(19) United States
(12) Patent Application Publication
(10) Pub. No.: US 2022/0324762 A1
(43) Pub. Date: Oct. 13, 2022

(54) ORGANO-MINERAL COMPOSITION FOR ACTIVATING PLANT GROWTH

(71) Applicant: Entomo Ventures Pte. Ltd., Singapore (SG)

(72) Inventors: Dmitry Mikhaylovich MIKHAYLOV, Moscow (RU); Aleksei Valentinovich KRAMARENKO, Cheboksary (RU); Ilman SHAZHAEV, Dubai (AE)

(21) Appl. No.: 17/225,367

(22) Filed: Apr. 8, 2021

(51) Int. Cl. C05C 3/00

(52) U.S. Cl. CPC C05C 3/00

(57) ABSTRACT

The invention relates to agriculture, to the stimulation of plant growth and as an additive to the substrate or soil. The composition activates plant growth and induces resistance to biotic and abiotic stresses, reduces the frequency of damage to the root system by micromycetes. Composition The composition includes the frass of the insect Hermetia illucens, which contains minerals such as: nitrogen, potassium, sodium, magnesium, sulfur; succinate and citrate as an acidity regulator; and at least one carboxylic acid and/or at least one amino acid; and at least one chelate compound. The pH of the composition is from 5.5 to 10.0.

### FIELD OF THE INVENTION

The solution seems to use a balanced, microelement composition and several polyfunctional compounds, but derived from the application and combined with non-toxic and completely safe for the environment substances, which are based on the insect frass Hermetia illucens with added plant nutrition elements and organic substances that stimulate plant growth and increase plant resistance to biotic and abiotic stresses.

The present invention is the preparation of an organo-mineral composition recommended for application to a substrate or soil in organic farming, in hydroponic substrates, saline and degraded soils, closed soils (greenhouses), aquaponics, when growing various plants and capable of giving maximum effect with sufficiently small doses of application.

The technical result, after applying the composition, is achieved: reducing the salinity of the soil, increasing the fertility of soils and substrates, stimulating plant growth, plant resistance to biotic and abiotic stresses, reducing the incidence of micromycetes, rapid growth of the root system.

### BACKGROUND OF THE INVENTION

Population growth and land degradation for agricultural production in many countries require changes to existing strategies that can meet future food needs and conserve soil resources.

The main causes of land degradation are intensive land use and excessive soil mineralization, resulting in depletion of organic matter and the fertile layer and a decrease in the supply of nutrients and trace elements, a decrease in the level of soil microorganisms and low crop yields. Also, one of the problems of soil fertility is a renewable source of effective and safe organic substances.

One of the rational solutions to the existing problem of organic waste disposal is the possibility of processing organic waste by Hermetia illucens larvae, with the production of frass, the basis of which can be used as an effective organic fertilizer supplemented with mineral and plant growth-stimulating substances in dissolved form, for uniform distribution over the entire volume of the mass of frass.

The erect-winged insects are cultivated in agriculture for the purpose of obtaining the valuable properties they possess. For example, the most widespread in the cultivation of insects, as a dietary food of humans, were the larva of the silkworm, the house cricket Acheta Domesticus.

The cultivation of insects is associated with a number of requirements for their content, which include climatic conditions and diet. Depending on the compliance with these conditions, such as temperature, humidity, quality and balance of the feed, not only the level of the insect's protein mass content depends, but also the level of their fertility and life span, and ultimately the effectiveness of the bioconversion.

The larvae of the black soldier fly or Hermetia illucens are a phytosaprophage that uses various organic waste, as well as animal and human waste products, as food.

Currently, the utilization of organic waste to produce a protein product for cultivated fish and farm animals and poultry, as well as the production of organic fertilizer from frass, as a plant growth regulator, as well as stimulating the development of rhizosphere and nodule bacteria as additives to the substrate or soil.

Due to the characteristics of the organism and the enzyme system of the Hermetia illucens larva, the released frass has moisture-intensive, porous and breathable particles with absorbent properties.

Within the scope of the present invention, these properties are an advantage in terms of using a frass base supplemented with minerals as a fertilizer, since the hygroscopicity and air pores, during the production of an organo-mineral composition, are filled with minerals, which ultimately increases the duration and uniform release of the nutrients of the composition.

In some studies noted that the frass is promising for use as a stimulant of growth and development of plants (see Kalova M and M Borkovcova 2013 Acta Universitatis Agriculturae et Silviculturae Mendelianae Brunensis. 61 77-83)
(see Cai M, Zhang K, Zhong W, Liu N, Wu X, Li W, Zheng L, Yu Z and Zhang J 2019 Waste and Biomass Valor. 10 265-73].

### SUMMARY OF THE INVENTION

In one aspect, the composition, as an additive to the substrate or soil, for reducing soil salinity, increasing fertility, stimulating plant growth and resistance to stress factors caused by biotic and abiotic stresses, reducing the incidence of micromycetes, promoting root system growth. The composition includes the insect frass Hermetia illucens, which contains minerals such as: nitrogen, potassium, sodium, magnesium, sulfur; succinate and citrate, as an acidity regulator; alcohol; and at least one carboxylic acid and/or at least one amino acid; and at least one chelate compound. The pH of the composition is from 5.5 to 10.0.

Additional features and advantages of the invention will be set out in the description that follows, and will be partially obvious from the description or can be studied by the practice of the invention. The advantages of the invention will be realized and achieved by a structure specifically specified in the written description and claim.

It should be understood that both the above general description and the following detailed description are exemplary and explanatory and are intended to further explain the claimed invention.

the Term “Frass” in the context of the present invention, is understood as referring to the excrement of insect larvae Hermetia illucens, which includes the natural release of larvae, the larval exuviae, undigested material such as uneaten food, products of metabolism, chitin, and organisms like bacteria, micromycetes. In the context of the present invention, frass is a relatively dry substance whose mass fraction of dry matter is approximately 70% to 90%.

The term “liquid solution” in the context of the present invention is understood as an aqueous composition containing dissolved minerals such as nitrogen, potassium, sodium, magnesium, sulfur; succinate and citrate, alcohol as an acidity regulator; and at least one trace element and/or at least one carboxylic acid and/or at least one amino acid; and at least one chelate compound; and uniformly introduced into frass by any available mechanisms and technologies.

The term “composition” or “organo-mineral composition”, in the context of the present invention, is understood as a finished organo-mineral fertilizer obtained by mixing frass and minerals and other substances, such as nitrogen, potassium, sodium, magnesium, sulfur, as well as succinate and citrate, alcohol; and at least one trace element and/or at least one carboxylic acid and/or at least one amino acid and at least one chelate compound. The composition is used as a fertilizer or soil additive, for example, if the application standards are met, in accordance with the selected characteristics of the plants and the soil or substrate.

### DETAILED DESCRIPTION OF PREFERRED EMBODIMENTS OF THE INVENTION

Reference will now be made in detail to the preferred embodiments of the present invention.

The advantage of the invention is the ability of the composition to reduce the amount of salts in the soil and substrates, to increase the stress resistance of plants during the growing season. One of the advantages of this invention is the relatively easy availability of all the substances available in the composition. One aspect of the novelty of the invention is the composition resulting in combined solutions of the selected substances and new synergistic properties.

The invention provides an organo-mineral composition for plant growth and resistance to factors caused by biotic and abiotic stress. The aggregate composition is solid, powdery and contains organic frass compounds; contains minerals such as: nitrogen, phosphorus, potassium; also contains succinate and citrate as an acidity regulator; and at least one trace element and/or at least one carboxylic acid and/or at least one amino acid and at least one chelate compound. The pH of the composition is from 5.5 to 10.0.

The essence of the invention consists in creating an organo-mineral composition, which is a base of the organic compound frass, and in which a liquid solution is introduced, containing minerals and other substances such as nitrogen, phosphorus, potassium; as well as succinate and citrate as an acidity regulator; alcohol; and a trace element and/or at least one carboxylic acid and/or at least one amino acid and at least one chelate compound.

All substances of the organo-mineral composition have their own purpose, are not antagonists in relation to each other, mutually complement and enhance the property of each substance.

to illustrate the mechanism of action of the composition according to the present invention is as follows: the obtained organo-mineral composition is applied to soil or substrate, and chemical absorption and formed covalent bonds, with varying degrees of speed of response, depending on the environment, gradually, under the influence of including soil moisture, releases minerals and inductors, allowing the plant to use throughout the entire period of vegetation, and to develop soil bacteria.

An illustration of the mechanism for obtaining the composition according to the present invention is as follows: a liquid solution containing mineral substances such as: nitrogen, phosphorus, potassium; also containing succinate and citrate as an acidity regulator; and at least one trace element and/or at least one carboxylic acid and/or at least one amino acid, and at least one chelate compound is introduced by various available mechanisms and methods into the frass throughout the volume, and getting on the surface of the frass, enriches it with nutrients. As an example of a mechanism for applying a liquid solution of the composition, you can use a controlled-action spray gun.

Alcohol contained in the liquid solution of the composition, as a dispersing agent for dissolving water-soluble compounds in water, and is also used as a disinfectant for pathogenic bacteria contained in frass.

As an example of such a solvent, propylene glycol C3H8O2 is used, which is about 1.0% to about 15% of the total volume of the liquid solution composition introduced into frass, preferably from 1.0% to 9.0% of the total volume. Alternatively, ethanol C2H5OH can be used, representing from about 1.0% to about 10.0% of the total volume of liquid dissolved composition introduced into frass.

Potassium succinate and sodium succinate were chosen for the composition because of its ability to stimulate linear growth (stretching) of plants; to stimulate the regeneration of plant leaves during micro-cloning and their reproduction (reproduction to reduce the chlorosis of plant tissues during micro-cloning. (see Buntsevich L. L., Impact of growth regulators which were not used earlier in clonal micropropagation on microshoots of plum in vitro, The Scientific Journal of the Kuban State Agrarian University, No. 115(01), 2016, UDC 573.6:634.11:631.53).

An example of a succinate used in the invention may be potassium succinate (K2C4H4O4) in an amount of 0.05% to 4.0% of the total composition of the liquid solution introduced into the frass, preferably from 0.15% to 2.9% by volume of the total composition of the liquid solution introduced into the frass. Or sodium succinate (Na2C4H4O4) in an amount of 0.2% to 3.0% by volume of the total composition of the composition, preferably from 0.15% to 2.9% by volume of the total composition of the liquid solution applied to frass.

The use of citric acid in a liquid solution of the composition is associated with its participation in the Krebs cycle, its use as an acidity regulator in a liquid solution of the composition, as well as its ability to inhibit stem growth and activate the accumulation of phenolic compounds (see T. A. Krasinskaya, I. N. Ostapchuk; Influence of succinic and citric acids on the morphophysiological development of grape plants at the stage of rearing after micro-multiplication; Fruit and Berry Growing in Russia, volume 57 (2019); https://doi.org/10.31676/2073-4948-2019-57-74-82)

An example of a citrate used in the invention may be citrate in the form of citric acid or citric acid salt, in an amount of 0.05% to 4.0% of the total composition of the liquid solution introduced into the frass, preferably from 0.10% to 3.0%.

The substances used in the present invention also contain such important elements as nitrogen, potassium, sodium, magnesium and sulfur.

Nitrogen is part of the protoplasmic proteins of the plant cell, and tkzhe is part of the nucleic acids of both RNA and DNA, which are essential in metabolism.

Nitrogen is contained in chlorophyll, phosphatides, and alkaloids, and its lack affects the normal development of plants.

As an example of the nitrogen used in the invention, nitrogen in the form of ammonium sulphate H8N2O4S, in an amount of 0.5% to 5.0% of the active substance, of the total composition of the liquid solution introduced into the frass, preferably from 0.5% to 1.0%.

Potassium stimulates the normal course of photosynthesis, increases the outflow of carbohydrates from the leaf blade to other organs, as well as the synthesis of sugars and high—molecular carbohydrates-starch, cellulose, pectin substances, xylans. By promoting the accumulation of carbohydrates in plant cells, potassium increases the osmotic pressure of the cell juice and thereby increases the cold resistance and frost resistance of plants.

Accumulating in chloroplasts and mitochondria, potassium stabilizes their structure and promotes the formation of ATP. Potassium increases the hydrophilicity of protoplasmic colloids; it reduces transpiration, which helps plants better tolerate short-term droughts. An example of the potassium used in the invention may be potassium hydroxide KOH, in an amount of 0.05% to 1.0% of the total composition of the liquid solution introduced into the frass, preferably from 0.10% to 1.0%.

The role of sodium is to transport nutrients across cell membranes, regulating the delivery of carbohydrates in plants. Also, if the plants are well supplied with sodium, their winter hardiness increases, and the lack of sodium worsens the formation of chlorophyll, and also provokes the appearance of chlorosis and necrosis in the leaves of plants, slowing down flowering. An example of the sodium used in the invention may be sodium hydroxide NaOH, in an amount of 0.05% to 1.0% of the total composition of the liquid solution introduced into the frass, preferably from 0.10% to 1.0%.

Magnesium is a part of plant chlorophyll, participates in photosynthesis, stimulates the activity of many enzymes involved in the formation and conversion of carbohydrates, proteins, organic acids, fats; affects the movement and conversion of phosphorus compounds, fruit formation and seed quality; accelerates the maturation of grain seeds; improves the quality of the crop. As an example of the magnesium used in the invention, there may be magnesium sulfate containing approximately 17% magnesium, in an amount of 0.02% to 6.0% of the active substance, of the total composition of the liquid solution introduced into the frass, preferably from 0.10% to 1.0%.

Sulfur is the most important element of plant mineral nutrition, which is part of plant proteins, and is a structural component of some of the most important amino acids—cysteine, cystine, methionine, which also plays an important role in redox processes, enzyme activation, protein synthesis, and chlorophyll synthesis. As an example of the sulfur used in the invention, magnesium sulfate may contain approximately 13% sulfur, in an amount of 0.02% to 2.0% of the active substance, of the total composition of the liquid solution introduced into the frass, preferably from 0.10% to 1.0%. Another example is ammonium sulfate containing approximately 24% sulfur in an amount of 0.05% to 1.0% of the active substance, of the total liquid solution composition applied to frass, preferably 0.10% to 1.0%.

According to one aspect of the invention, the composition includes amino acids that activate the mechanisms of plant growth after salt stress and low temperature, increase the formation of fruit ovaries, as well as increase the ability to absorb nutrients and resistance to pests and diseases. The amino acid can be any of the following: aspartic acid C4H7NO4, 2-aminopropanoic acid C3H7NO2, 2-amino-5-guanidine pentanoic acid C6H14N4O2. Amino acids preferably make up from 0.001% to 1.5% of the total composition of the liquid solution introduced into the frass.

Plants better absorb natural α-amino acids in the optically active L-configuration, which includes proteins. Such changes are easily accepted by the plant organism and are quickly incorporated into the metabolism as their own.

The substances used in the organo-mineral composition of the present invention also contain an element such as chitin.

Chitin (C8H13NO5) n contained in frass as a larval exuvium is an environmentally friendly compound that is easily destroyed by microorganisms. The use of chitin contributes to an increase in the chitinase activity of chitinolytic microorganisms, leading to a decrease in the population of parasitic nematodes and an increase in the number of saprobiotic ones. The nematodocidal effect is associated with an increase in the concentration of ammonia during the hydrolysis of chitin. The negative characteristics of chitin are weak solubility due to the high rigidity of the polymer chain and intense intermolecular interaction, phytotoxicity in the release of ammonia and high consumption rates. (see Zh. V. Udalova, V. B. Udalova, S. V. Zinoviev; The use of chitin and chitosan in the fight against phytoparasitic nematodes; The Center of Parasitology of the IPEE named after A. N. Severtsov of the Russian Academy of Sciences, All-Russian Research Institute of Helminthology named after K. I. Scriabin, 2011).

The chitin content in the composition is from 0.2% to 2.0% of the total volume, preferably from 0.3% to 1.0%.

The proportions of the liquid solution introduced into the frass of the insect Hermetia illucens range from 1.0% to 10% of the total volume of the organo-mineral composition.

The pH of the composition should be between 5.5 and 10.0, preferably 7.0 to 8.5.

What is claimed is:

1. Composition for activating plant growth and resistance to stress factors caused by biotic and abiotic stress, including:
includes dry frass of insects Hermetia illucens in which a composition is introduced in the form of a liquid solution, including such substances as:
alcohol in an amount from 1.0% to 15.0% of the total composition of the liquid solution nitrogen in an amount from 0.5% to 5.0% of the total composition of the liquid solution;
potassium in the amount of 0.05% to 1.0% of the total composition of the liquid solution;
sodium in the amount of 0.05% to 1.0% of the total composition of the liquid solution;
magnesium in the amount of 0.02% to 6.0% of the total composition of the liquid solution;
sulfur in the amount of 0.02% to 2.0% of the total composition of the liquid solution;
also containing succinate in an amount of 0.05% to 4.0% of the total composition of the liquid solution;
citrate in the amount of 0.05% to 4.0% of the total composition of the liquid solution;
and at least one carboxylic acid and/or at least one amino acid in an amount of 0.001% to 1.5% of the total composition of the liquid solution;
and at least one chelate compound.
In addition, chitin was added to the organo-mineral composition in an amount of 0.2% to 2.0% of the total composition of the organo-mineral composition
The proportions of the applied liquid solution in the insect frass Hermetia illucens range from 1.0% to 10% of the total volume of the composition.
The pH of the composition is from 5.5 to 10.0.

2. A composition according to claim 1, in which the alcohol is any of propylene glycol, or ethyl alcohol, and in which the alcohol is used as a dispersing agent to dissolve water-soluble compounds in water, from about 1.0% to about 10.0% of the total composition of the liquid solution introduced into frass.

3. The composition according to claim 1, in which the succinate is potassium succinate (K2C4H4O4) in an amount of 0.15% to 2.9% of the total composition of the liquid solution introduced into frass.

4. The composition according to claim 1, in which citrate is citric acid, in an amount of 0.10% to 3.0% of the total volume of the composition of the liquid solution applied to frass

5. The composition according to claim 1, in which nitrogen is ammonium sulphate H8N2O4S, in an amount of 0.5% to 1.0% of the active substance, from the total volume of the composition of the liquid solution introduced into frass.

6. The composition according to claim 1, in which the potassium is potassium hydroxide KOH, in an amount of 0.10% to 1.0% of the total composition of the liquid solution introduced into the frass.

7. The composition according to claim 1, in which sodium is sodium hydroxide NaOH, in an amount of 0.10% to 1.0% of the total volume of the composition of the liquid solution introduced into frass.

8. The composition according to claim 1, in which magnesium is magnesium sulfate in an amount of 0.10% to 1.0% of the active substance, from the total volume of the composition of the liquid solution introduced into frass.

9. A composition according to claim 1, in which in which sulfur is an ammonium sulfate contains approximately 24% sulfur in an amount of from 0.10% to 1.0% for the active substance, of the total composition of the liquid solution introduced in the frass.

10. A composition according to claim 1, in which the amino acid is any of the following: aspartic acid C4H7NO4, 2-aminopropanol C3H7NO2 acid, 2-amino-5-guanidinopentanoic acid, C6H14N4O2, an amount of from 0.001% to 1.5% of the total composition of the liquid solution introduced in the frass.

11. The composition according to claim 1, in which chitin is an exuvium of Hermetia illucens larvae in an amount from 0.3% to 1.0% of the total volume of the organo-mineral composition

12. The composition according to claim 1, in which the chelated compound includes potassium, sodium, magnesium, sulfur.

13. The composition according to claim 1, in which the proportion of the liquid solution introduced into the frass of the insect Hermetia illucens is from 1.0% to 10% of the total volume of the organo-mineral composition.

14. The composition according to claim 1, in which the pH of the organo-mineral composition is from 7.0 to 8.5
